(19) United States
(12) Patent Application Publication
(10) Pub. No.: US 2018/0106602 A1
(43) Pub. Date: Apr. 19, 2018

(54) FILL LEVEL MEASUREMENT DEVICE FOR DETERMINING THE TOPOLOGY OF A FILLING MATERIAL SURFACE

(71) Applicant: VEGA Grieshaber KG, Wolfach (DE)

(72) Inventors: Roland Welle, Hausach (DE); Steffen Waelde, Niedereschach (DE)

(21) Appl. No.: 15/786,069

(22) Filed: Oct. 17, 2017

(30) Foreign Application Priority Data
Oct. 17, 2016 (EP) 16 194 083.8

(51) Int. Cl. G01B 11/24; G01F 23/284

(52) U.S. Cl. CPC G01B 11/24; G01F 23/284

(57) ABSTRACT

A fill level measurement device can be provided for determining the topology of a filling material surface. The fill level measurement device can comprise an antenna array having at least three antenna apparatuses, each of which can be designed or configured to transmit a radar signal and to receive a signal reflected on the filling material surface. Furthermore, the fill level measurement device can comprises a control unit/device, the antenna array having at least three antenna faces, the surface normal vectors of which can be arranged transversely to one another, one antenna apparatus being arranged on each antenna face, so that a different solid angle range can be detected by each antenna apparatus. In this exemplary case, the antenna apparatuses can each be designed or configured to produce a measurement signal on the basis of on the reflected signal, and the control unit/device can be designed or configured to process the measurement signals from the antenna apparatuses further and/or to combine them to form a common measuring signal.

### CROSS-REFERENCE TO RELATED APPLICATION

This application claims the benefit of and priority from European Patent Application No. 16 194 083.8 filed on Oct. 17, 2016, the entire disclosure of which is incorporated herein by reference.

### FIELD OF PRESENT DISCLOSURE

The present disclosure generally relates to fill level measurement. In particular, the present disclosure relates to a fill level measurement device for determining a topology of a filling material surface, a method for determining the topology of the filling material surface, a system for a fill level measurement device, and a computer-readable medium storing a computer program therein for determining the topology.

### BACKGROUND INFORMATION

The detection of the topology of a filling material surface may, e.g., be advantageously applicable when measuring bulk materials and the bulk material cones that often occur in the process and extraction funnels inside or outside closed containers. The detection of a surface topology in order to determine fill levels and/or volumes may also be applicable to moving liquids. Moving liquids of this type occur, for example, when using stirring devices and in the flow patterns produced therefrom on the liquid surface (vortices). Determination of the surface topology may allow for conclusions regarding additional variables, such as the viscosity or degree of mixing of a filling material, optionally taking into account the speed of the stirring device.

Methods for contactless scanning of a surface can be based on, for example, the principle that a signal transmitted in the direction of a surface is reflected thereon and the propagation time and/or signal strength of the reflected signal is evaluated. In order to detect the topology of a filling material surface with sufficient precision, it may be important to carry out a large number of measurements in the direction of specific regions of a filling material surface, which may increase the complexity and costs for measurement devices or measuring methods of this type.

Accordingly, there is a need to address at least some of the issues and/or deficiencies described herein.

### OBJECTS AND SUMMARY OF EXEMPLARY EMBODIMENTS

According to an exemplary embodiment of the present disclosure, a fill level measurement device can be provided for determining, establishing and/or measuring the topology of a filling material surface. The filling material surface can, for example, be or include the surface of a bulk material and/or a liquid filling material, for example, in a container or on an open bulk material heap. The fill level measurement device can include an antenna array comprising at least three antenna apparatuses, and each of which can be designed to transmit a radar signal and to receive a signal reflected on the filling material surface.

Furthermore, the exemplary fill level measurement device can comprise a control unit/device which is configured to control the antenna array and/or the antenna apparatuses of the antenna array. The control unit/device can also be or include an electric control circuit, a control loop, an evaluation circuit and/or an evaluation unit for evaluating and/or processing measurement signals from the antenna array. The antenna array comprises at least three antenna faces, the surface normal vectors and/or surface normals of which can be arranged transversely to one another, one antenna apparatus being arranged on each antenna face so that a different solid angle range is detectable and/or can be detected by each antenna apparatus. One or more of the antenna apparatuses can be designed to produce a measurement signal that correlates with the reflected signal on the basis of the signal reflected by the filling material surface. For example, each of the exemplary antenna apparatuses can establish a spacing from the filling material surface and/or a portion of the filling material surface, the spacing being a measure of the fill level of the filling material in the detected angle range. The control unit/device can be configured to process the measurement signals from the antenna apparatuses further and/or to combine them to form a common measuring signal In particular, the control unit/device can be configured to establish the topology of the filling material surface by combining at least some of the measurement signals from the exemplary antenna apparatuses.

In one exemplary embodiment of the present disclosure, the antenna array can be or include a radar antenna. In another example, the antenna apparatuses can be or include independently working antenna units/devices, for example, part radar antennas and/or radar subgroups, each of which can be arranged on the antenna faces of the antenna array in such a way that a portion of the filling material surface can be detected by each antenna apparatus. The portions detected by the antenna apparatuses can at least partially overlap. In order for each of the antenna apparatuses to detect a portion of the filling material surface, the antenna apparatuses can be arranged on the antenna faces that are arranged obliquely and/or transversely to one another. The antenna faces can each, for example, be a lateral sub-surface of the antenna array. The surface normal vectors of the antenna faces can be arranged, oriented and/or extend transversely, orthogonally and/or so as not to be approximately, substantially or exactly parallel to one another in this case. The surface normal vectors can also extend askew with respect to one another. In other words, the antenna faces and the antenna apparatuses arranged thereon can be inclined relative to one another and/or with respect to one another. This exemplary arrangement of the antenna faces and the antenna apparatuses arranged thereon can advantageously facilitate that each of the antenna apparatuses can detect a different or another solid angle range and therefore a different portion of the filling material surface. A compact, robust, reliable, low-maintenance, low-wear and economical fill level measurement device can thus be advantageously provided, with which a half-space below the fill level measurement device, e.g., a total solid angle of approximately π and/or 180°, can be detected without components of the fill level measurement device having to be moved, for example rotated and/or pivoted.

This exemplary configuration can provide a compact, robust, reliable, low-maintenance, low-wear and economical fill level measurement device for determining the topology of a filling material surface.

According to another exemplary embodiment of the present disclosure, the solid angle ranges that can be detected by the antenna apparatuses can each be varied and/or changed by analogue and/or digital beam forming. In other words, the angle ranges that are detected by the antenna apparatuses can be changed by electronic beam deflection or methods for digital and/or analogue beam forming, e.g., analogue and/or digital beam forming can be carried out by each antenna apparatus. The main beam directions and/or the main receiving directions of each antenna apparatus relative to the associated surface normal vectors of the antenna faces can be changed by means of analogue and/or digital beam forming, so that reflection ratios can be detected in various angle directions and therefore various angle ranges. For example, a solid angle range that can be detected by the fill level measurement device can therefore be advantageously increased. In summary, using the antenna array according to an exemplary embodiment of the present disclosure and the control device, a fill level measurement device can be provided, which can facilitate a precise measurement of a half-space located below the fill level measurement device on the basis of the signals received by the antenna apparatuses and by using a method for digital and/or analogue beam forming.

Conventional antenna-based fill level measurement devices and/or evaluation methods for determining the topology of a bulk material surface without mechanical adjustment of a main beam direction of the antenna can facilitate the reflection ratios in various angle directions to be detected by analogue and/or digital beam forming. The topology of a bulk material surface below the antenna can, however, only likely be established reliably and with sufficient precision in a restricted angle range of approximately 60° relative to a mounting direction of the antenna. The topology of the surface of a bulk material can advantageously be measured up to an angle of +/−90° and the antenna array according to an exemplary embodiment of the present disclosure that comprises at least three antenna apparatuses inclined with respect to one another. Thus measurements in containers that are virtually completely filled with filling material can be obtained. In addition, the exemplary antenna faces and/or the antenna apparatuses can be configured to be substantially flat and/or planar, as a result of which the fill level measurement device is economical to produce measurement device.

According to a further exemplary embodiment of the present disclosure, an angle of deflection between a main beam direction of each antenna apparatus and the associated surface normal vector of the antenna face is in a range of +/− approximately, substantial or exactly 45°. The angle of deflection can be measured between the main beam direction of an antenna apparatus and the surface normal vector of the antenna face on which this antenna apparatus is arranged. With the angle of deflection range designated above, which can be, e.g., a maximum detectable angle range of an antenna apparatus, it can be ensured that the overall topology of the filling material can be established, determined and/or measured with high precision in a half-space below the fill level measurement device.

According to still another exemplary embodiment of the present disclosure, the antenna apparatuses can each comprise at least one transmitting element/device configured to transmit the radar signal and at least two receiving elements/devices configured to receive the reflected signal. Alternatively or in addition, the antenna apparatuses each comprise at least two transmitting elements/devices for transmitting the radar signal and at least one receiving element/device for receiving the reflected signal. The transmitting elements/devices and the receiving elements/devices can be antenna elements/devices of the fill level measurement device. For example, the antenna elements/devices can be formed as or include waveguide elements, patch elements, horn antenna elements, dielectric antenna elements and/or rod elements. The antenna elements/devices can be configured for transmitting and receiving, e.g., the transmitting elements and the receiving elements can have an identical structure. The transmitting elements and the receiving elements can also be different.

In general, a compact, robust, reliable, economical and precise fill level measurement device for detecting the topology can be provided by mounting at least one transmitting element/device and at least two receiving elements/devices or by mounting at least two transmitting elements/devices and at least one receiving element/devices on each of the antenna faces, an antenna array standing on its head, for example, in the form of a pyramid standing on its head and/or a truncated pyramid standing on its head, in combination with methods for analogue and/or digital beam forming.

According to yet another exemplary embodiment of the present disclosure, the transmitting elements/devices and the receiving elements/devices of the antenna apparatuses can be arranged over the entire surface of the associated antenna faces. For example, the transmitting elements and the receiving elements can be arranged as an array in one or more rows and/or columns on the antenna faces. Alternatively or in addition, directly adjacent transmitting elements and/or receiving elements of each antenna apparatus can be spaced apart from one another at a spacing of less than or equal to half the wavelength of the radar signal. In other words, transmitting elements and/or receiving elements arranged directly adjacently to one another on an antenna apparatus can be spaced apart from one another by less than or equal to half the wavelength of the radar signal. The center frequency of the radar signal can be approximately, substantial or exactly 79 GHz, for example, which corresponds to a wavelength of approximately, substantial or exactly 3.8 mm, so that the maximum spacing between two directly adjacent transmitting elements and/or receiving elements can be approximately, substantial or exactly 1.9 mm. Advantageously, secondary grating lobes can be avoided and better focusing of the antenna apparatuses can be achieved by such a spacing.

According to a still further exemplary embodiment of the present disclosure, the transmitting elements/devices and the receiving elements/devices of the antenna apparatuses can be arranged in a T shape on the associated antenna faces. In other words, the transmitting elements and/or the receiving elements can be distributed and/or arranged in a T-shaped geometry on at least one of the antenna faces, in particular on each of the antenna faces. For example, the horizontal leg of the T shape can comprise only transmitting elements and the vertical leg can comprise only receiving elements, or vice versa. In general, on one or more antenna faces, the transmitting elements can be arranged in a first row and the receiving elements may be arranged in a second row. Adjacent transmitting elements can also be offset with respect to one another relative to a middle, a center and/or a center line of the first row. Likewise, adjacent receiving elements can be offset with respect to one another relative to a middle, a center and/or a center line of the first row. The first row can extend transversely to the second row and/or may run transversely to the second row and/or may be arranged transversely to the second row in this case. In particular, the first row can extend substantially orthogonally to the second row and thus form the T shape. With suitable multiplexing, e.g., time multiplexing, of the transmitting elements and/or of the receiving elements and by suitably evaluating the reflected signals received by each receiving element, a collection of echo curves corresponding to a rectangular arrangement of a virtual array can thus be identified. Furthermore, the number of transmitting elements and/or receiving elements and therefore production costs of the fill level measurement device can advantageously be reduced by this method.

According to a still further exemplary embodiment of the present disclosure, the position of the antenna array relative to the control unit is fixed. For example, the antenna array can be statically and/or rigidly connected to the control unit/device. As a result, wear of mechanically movable components can be advantageously reduced and/or avoided, for example, in comparison with rotatable and/or pivotable antenna arrays.

According to another exemplary embodiment of the present disclosure, the antenna apparatuses can be operated and/or activated one after the other, each in different frequency bands, and/or using a code multiplexing method. This can be triggered, controlled and/or regulated by the control device, for example, facilitating that the radar signals from the individual antenna apparatuses do not influence one another and can be differentiated from one another. In the code multiplexing method, an individual code for the particular antenna apparatus is superposed on the radar signal, for example, so that the reflected signals can in turn be associated with the individual antenna apparatuses using the code.

According to yet another exemplary embodiment of the present disclosure, the three antenna faces form lateral surfaces of a pyramid or a truncated pyramid of the antenna array. In other words, the antenna array can be pyramid-shaped, in the form of a truncated pyramid and/or may have a pyramidal structure. A tip of the pyramid-shaped antenna array can, for example, be oriented in the direction of the filling material surface. This can facilitate that a half-space having a solid angle of at least π can be detected by the antenna array. Alternatively or in addition, the antenna faces are connected to one another, at least in part. For example, rims and/or edges of the antenna faces can be connected to one another and thus form the pyramidal structure.

According to a further exemplary embodiment of the present disclosure, the antenna array can comprise more than three antenna apparatuses and more than three antenna faces, with one exemplary antenna apparatus being arranged on each of the antenna faces. This can increase the accuracy of the determination of the topology of the filling material surface by increasing the directions detected.

According to an additional exemplary embodiment of the present disclosure, the antenna array can have a top face, on which a further antenna apparatus is arranged. For example, the top face can form a tip of a truncated pyramid. For example, a horn antenna and/or a further antenna apparatus can be arranged on the truncated pyramid, with which a fill level measurement can be carried out at regular intervals for plausibility checks.

In still a further exemplary embodiment of the present disclosure, the control unit/device can be designed and/or configured to establish and/or to calculate the topology of the filling material surface, the density value of a filling material, the mass of the filling material, the volume of the filling material and/or the viscosity of the filling material on the basis of at least some of the measurement signals from the antenna apparatuses. Variables of this type can be established, for example, on the basis of the common measurement signal or a measured value resulting therefrom. Variables of this type can also be obtained by processing the individual measurement signals from the antenna apparatuses. Further variables that are characteristic of the filling material, such as the dielectric constant or grain size of the filling material, can also be taken into account in order to calculate the variables mentioned above.

According to a further exemplary embodiment of the present disclosure, a method can be provided for determining the topology of a filling material surface using a fill level measurement device, which can comprise a control unit/device and an antenna array having at least three antenna apparatuses, each arranged on an antenna face, the surface normal vectors of the antenna faces being arranged approximately, substantial or exactly transversely to one another. The method can comprise the following procedures:

transmitting a radar signal by means of each of the antenna apparatuses;

receiving a signal reflected on the filling material surface with each of the antenna apparatuses;

producing a measurement signal correlating with the reflected signal using each antenna apparatus; and

combining the measurement signals from the antenna apparatuses to form a common measurement signal with the control unit/device.

Features and elements of the fill level measurement device described herein can be features and exemplary procedures of the method described herein, and vice versa.

In another exemplary embodiment of the present disclosure, a system can be provided with a computer program stored therein, which, when executed on a control unit/device of a fill level measurement device of the system, the control unit/device can instruct the fill level measurement device to carry out the procedures of the method described herein.

According to still another exemplary embodiment of the present disclosure, a computer-readable medium can be provided, on which a computer program can be stored, whereas, when the computer program is executed on a control unit/device of a fill level measurement device, the control unit/device instructs the fill level measurement device to carry out the procedures of the method described herein.

Exemplary embodiments of the present disclosure are described in the following with reference to the accompanying drawings. In the drawings, the same reference signs can denote elements that are identical, similar or have the same function.

Each and every exemplary embodiment and aspect described herein, and their components, portions, configurations, procedures and procedures can be performed, combined and interchanged with one or more of other exemplary embodiments and aspects described herein.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1A and 1B are cross-sectional views of a topology-detecting fill level measurement device according to certain exemplary embodiments of the present disclosure;

FIG. 2 is a cross-sectional view the topology-detecting fill level measurement device according to according to additional exemplary embodiments of the present disclosure;

FIG. 3A is a cross-sectional view of the topology-detecting fill level measurement device according to according to further exemplary embodiments of the present disclosure;

FIG. 3B is an antenna apparatus of the fill level measurement device shown in FIG. 3A;

FIG. 3C and 3D are exemplary virtual images of the antenna apparatus shown in FIG. 3B;

FIG. 4 is an illustration of the topology-detecting fill level measurement device according to another exemplary embodiment of the present disclosure;

FIG. 5 is an illustration of the topology-detecting fill level measurement device according to another exemplary embodiment of the present disclosure;

FIG. 6 is an illustration of the topology-detecting fill level measurement device according to another exemplary embodiment of the present disclosure;

FIG. 7 is a plan view of the topology-detecting fill level measurement device according to still another exemplary embodiment of the present disclosure;

FIG. 8 is a cross-sectional view of the topology-detecting fill level measurement device according to a further exemplary embodiment of the present disclosure;

FIG. 9 is a flowchart to illustrate exemplary procedures of a method for determining the topology of a filling material surface according to yet another exemplary embodiment of the present disclosure; and

FIG. 10 is a diagram of procedures of the method for determining the topology of a filling material surface according to a further exemplary embodiment of the present disclosure.

Throughout the drawings, the same reference numerals and characters, unless otherwise stated, are used to denote like features, elements, components, or portions of the illustrated embodiments. The views in the drawings are merely schematic and are not to scale. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

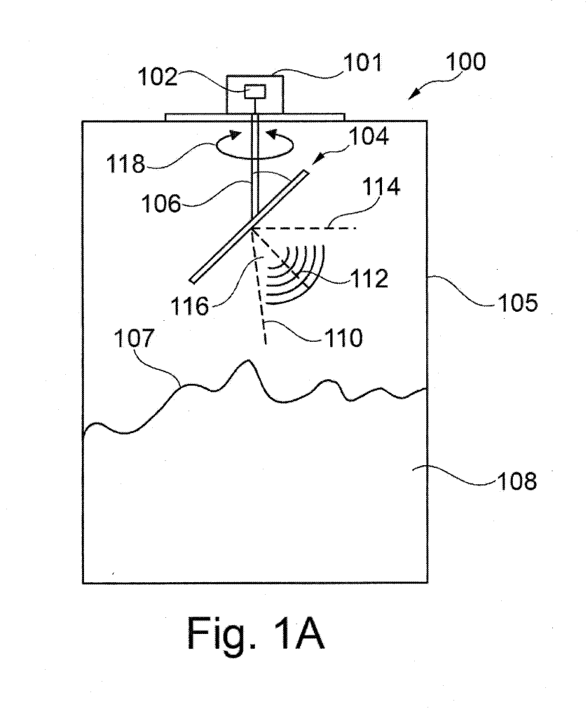

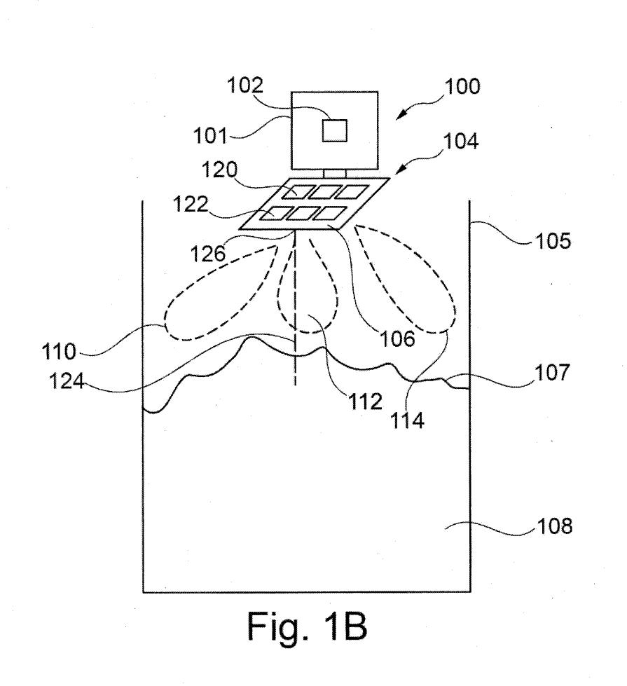

FIG. 1A shows a cross-sectional view of the topology-detecting fill level measurement device 100 according to an exemplary embodiment of the present disclosure. The fill level measurement device can comprise a control unit/device 101 having an electric control circuit 102 and an antenna apparatus 104. The fill level measurement device in FIG. 1A is configured as a rotating line scanner, the antenna apparatus 104 being connected and/or coupled to the control unit 101 by an antenna holder 106. Fill level measurement devices 100 of this type are used, in particular, for measuring bulk material in a container 105 or on an open heap, and it is possible to establish the course of the surface 107 of the bulk material 108 and/or the topology of the filling material surface 107 of the filling material 108.

The antenna apparatus 104 can be equipped with one or more transmitting elements and/or receiving elements, which can facilitate a change in the main beam direction and/or the main receiving direction 110, 112, 114 in pre-determinable angular values 116. Thus, echo signals and/or echo curves from the different main beam directions and/or main receiving directions 110, 112, 114 can be detected. By additional rotation 118 of the antenna holder 106, which can establish an axis 106, each point of the filling material surface 107 of the filling material 108 can therefore be measured. It can be advantageous in this combined device for electronic and mechanical beam deflection that, in electronic beam deflection, e.g., a maximum angle 116 of typically +/− approximately, substantially or exactly 45° can be set to facilitate a measurement of the whole container 105 up to the completely full state.

Because of the mechanical components used, such as the rotatable antenna holder 106, the fill level measurement device 100 shown in FIG. 1 may, however, be prone to wear and thereby be somewhat expensive.

FIG. 1B shows a further topology-detecting fill level measurement device 100 according to an exemplary embodiment of the present disclosure. Unless stated otherwise, the fill level measurement device 100 shown in FIG. 1B has the same or similar elements and features as the fill level measurement device 100 shown in FIG. 1A.

The fill level measurement device 100 shown in FIG. 1B can have a two-dimensional arrangement of transmitting elements 120 and/or receiving elements 122 on the antenna apparatus 104. The beam deflection used for measuring the filling material surface 107 can be achieved exclusively electronically here by methods for analogue and/or digital beam deflection. In this exemplary case, the main beam direction and/or the main receiving direction 110, 112, 114 can be changed electronically, e.g., without a mechanical movement of components of the fill level measurement device 100. However, it may be disadvantageous in this exemplary construction that a beam deflection in relation to the normal 124 or to the normal vector 124 of an antenna face 126 of the antenna apparatus 104 can only take place with sufficient precision in a range of +/− approximately, substantially or exactly 60°. It can therefore be difficult to measure the bulk material position and/or the filling material surface 107 of virtually completely full containers 105.

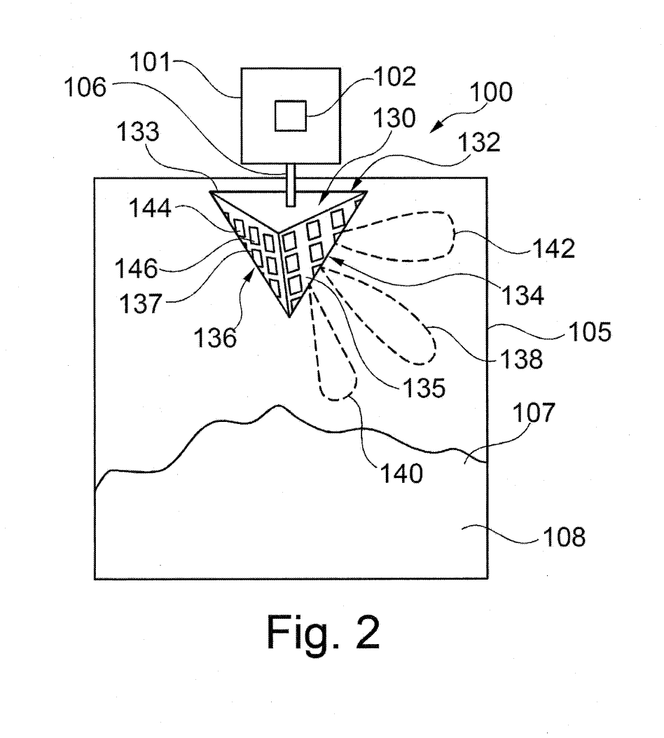

FIG. 2 shows the topology-detecting fill level measurement device 100 according to still another exemplary embodiment of the present disclosure. Unless stated otherwise, the fill level measurement device 100 of FIG. 2 has the same or similar features and elements as the fill level measurement devices 100 described herein and in the drawings.

The fill level measurement device 100 illustrated in FIG. 2 can comprise an antenna array 130, which is mechanically rigidly connected to the control unit 101 by means of a fastening device 106 and/or an antenna holder 106. Wear of components of the fill level measurement device 100 can effectively be reduced by this construction. Moreover, the exemplary antenna array 130 can have at least three antenna apparatuses 132, 134, 136. The antenna apparatuses 132, 134, 136 are each designed to transmit a radar signal and to receive a signal reflected on the filling material surface 107. The antenna apparatuses 132, 134, 136 can each be or include a sub-antenna and/or a radar subgroup 132, 134, 136 of the antenna array 130 here.

The antenna array 130 can also comprise at least three antenna faces 133, 135, 137, on each of which one of the antenna apparatuses 132, 134, 136 can be arranged. In the exemplary embodiment shown in FIG. 2, the antenna array 130 is pyramid-shaped, each of the antenna faces 133, 135, 137 being connected to one another and forming the lateral surfaces of the pyramid-shaped antenna array 130. The antenna array 130, as it were, has a pyramidal shape, the tip of which faces the filling material surface 107. The surface normal vectors of the antenna faces 133, 135, 137 are oriented transversely to one another, so that a different solid angle range 138, corresponding to the main beam direction and/or main receiving direction of each antenna apparatus 132, 134, 136, is detected by each of the antenna apparatuses 132, 134, 136. For the sake of clarity, only the solid angle range 138 detected by antenna apparatus 134 is shown in FIG. 2, but is certainly not limited by such illustration.

Each antenna apparatus 132, 134, 136 can achieve a beam deflection in a pre-determinable angle range 138, 140, 142 with the aid of analogue and/or digital beam forming. In other words, the solid angle range 138 detected by antenna apparatus 134 can be varied with respect to the regions 140, 142 by means of methods of analogue and/or digital beam forming. The same can apply to the antenna apparatuses 132, 136 (not shown).

For this exemplary purpose, each of the antenna apparatuses 132, 134, 136 can have at least two or a plurality of transmitting elements 144 and/or receiving antennas 146. The transmitting elements 144 and/or the receiving elements 146 can be distributed over the entire surface of and/or uniformly on the antenna faces 133, 135, 137 here. For example, the transmitting element 144 and/or the receiving elements 146 can be arranged in rows and columns on the antenna faces 133, 135, 137. A spacing between two adjacent transmitting elements 144 and/or receiving elements 146 can be less than or equal to approximately or substantially half the wavelength of the radar signal here. On account of the angular position of the antenna apparatuses 132, 134, 136 that can advantageously result from the pyramidal structure and/or pyramid shape of the antenna array 130, adjustment of large angles of deflection by means of analogue and/or digital beam forming can be dispensed with. The angle of deflection may be defined as the angle of the main beam direction and/or the main receiving direction of an antenna apparatus 132, 134, 136 with respect to the normal and/or the normal vector of the associated antenna face 133, 135, 137. Typical values for angles of deflection that are actually to be adjusted are in the range of +/− approximately, substantially or exactly 45°, which can be achieved by the methods for analogue and/or digital beam deflection without losses that are all too great with respect to the half-power width of the antenna being adjusted. Since each of the antenna apparatuses 132, 134, 136 can only detect part and/or a portion of the filling material surface 107 when angles of deflection are set in the range of +/− approximately, substantially or exactly 45°, the complete surface profile and/or the complete topology of the filling material surface 107 is only produced by the combination of the measurement signals established by the antenna apparatuses 132, 134, 136. For example, each of the antenna apparatuses 132, 134, 136 can be designed to determine a spacing value from the filling material surface 107, and the control unit 101 can be designed to combine the individual spacing values. Alternatively or in addition, the antenna apparatuses 132, 134, 136 can each produce a measurement signal correlating with the reflected signals, and the measurement signals of the individual antenna apparatuses 132, 134, 136 can either be directly combined by the control unit 101 or can be processed further for determining individual spacing values, for example.

To summarise, the fill level measurement device 100 can comprise a radar or an antenna array 130 consisting of a plurality of radar subgroups 132, 134, 136 standing alone per se in the form of antenna apparatuses 132, 134, 136. The overall radar antenna 130 can, for example, be a pyramid or a truncated pyramid, it being possible for a radar subgroup 132, 134, 136 to be arranged on each lateral sub-surface or antenna face 133, 135, 137 of the pyramid and it being possible for analogue and/or digital beam forming to be carried out by each radar subgroup 132, 134, 136.

As an alternative to the pyramid-shaped configuration of the antenna array 130 described above, in which the individual antenna faces 133, 135, 137 are, e.g., directly connected to one another, the individual antenna faces 133, 135, 137 can also be spaced apart from one another and arranged and/or fastened, for example, on a holding structure and/or support structure. For example, the individual antenna faces can be connected and/or coupled to one another by means of rigid or movable and/or resilient elements. The holding structure can also be configured in such a way that an orientation of the antenna faces 133, 135, 137 can be changed, for example by mechanical adjustment. For example, the diameter of the antenna device can be reduced by a mechanical adjustment during mounting in a container. As a result, it is possible for the antenna to also be guided through a connecting piece having a small diameter. This may facilitate the use of the fill level measurement device in containers having small connecting pieces.

Furthermore, the antenna apparatuses 132, 134, 136 can each be individually deactivated. This may be preferred, for example, if one of the antenna apparatuses 132, 134, 136 is arranged in the direct vicinity of a container wall of the container 105 and can thus only receive signals reflected by the container wall.

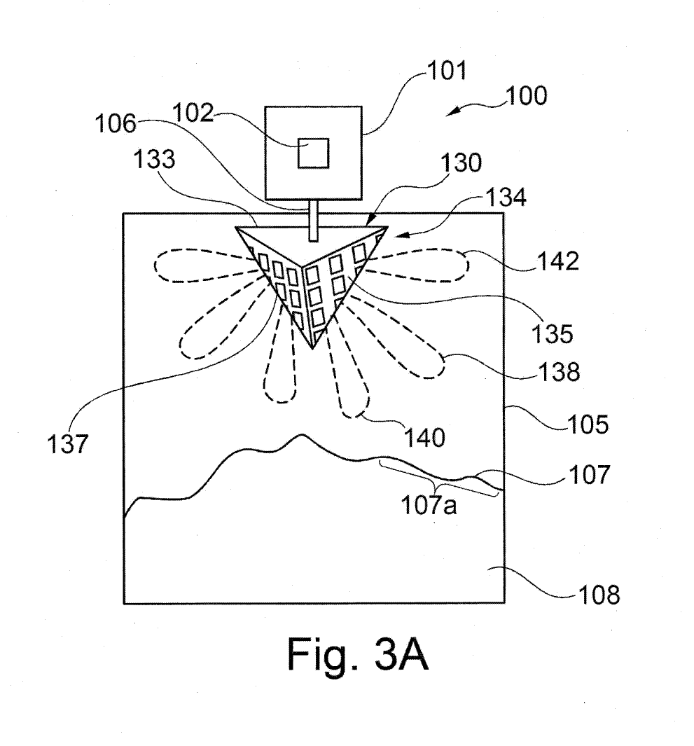

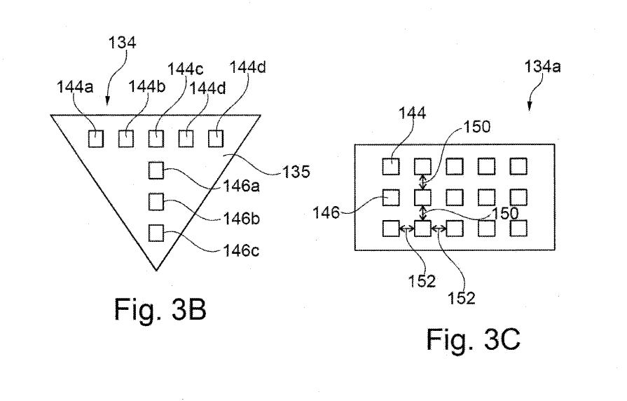

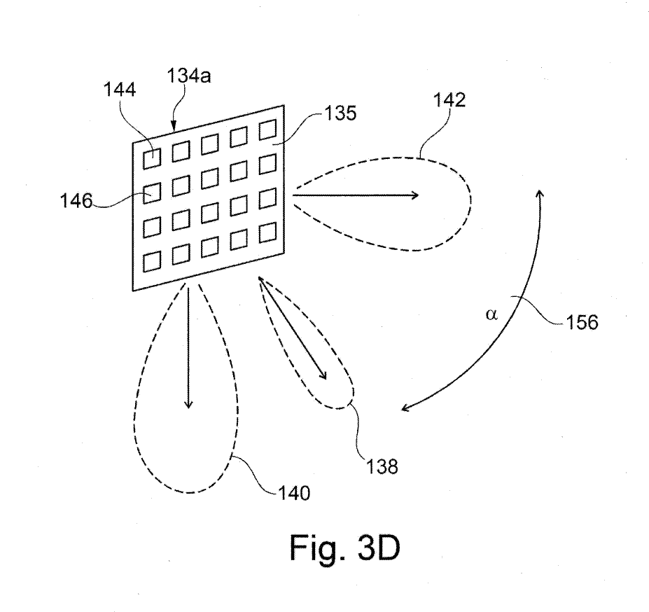

FIG. 3A shows the topology-detecting fill level measurement device 100 according to still a further exemplary embodiment of the present disclosure. FIG. 3B shows an antenna apparatus 134 of the level measurement device 100 illustrated in FIG. 3A. FIG. 3C and 3D each show a virtual image 134 and/or a virtual array being produced on the antenna apparatus 134 illustrated in FIG. 3B. Unless stated otherwise, the fill level measurement device 100 illustrated in FIG. 3A to 3D has the same features and elements as the fill level measurement devices 100 described herein and shown in the drawings.

For example, the entire surface of the antenna faces 133, 135, 137 of the pyramid-shaped antenna array 130 of the fill level measurement device 100 in FIG. 3A is no longer covered with transmitting elements 144a-d and/or receiving elements 146a-c, but in the shape of a “T”. The complexity of the fill level measurement device 100 can be reduced by this arrangement without losing measuring precision.

FIG. 3B shows the T-shaped arrangement of the transmitting elements 144a-d and the receiving elements 146a-c on the antenna face 135 for the antenna apparatus 134 in detail. The rest of the antenna apparatuses 132, 136 and/or the rest of the antenna faces 135, 137 of the antenna array 130 have a similar design. The transmitting elements 144a-144d are arranged in a row and form the horizontal leg of the “T”, the transmitting elements 144a-144d being activated, actuated and/or operated consecutively by the control unit 101 of the fill level measurement device 100 in the time multiplexing method. The receiving elements 146a-146c are arranged in a column and form the vertical leg of the “T”, thus it is possible for the signals reflected on the bulk material surface 107 to be received by the receiving elements 146a-146c. Using a suitable evaluation of the received echo signals carried out by the control unit/device 101 and/or an electronics system of the antenna apparatus 134, a collection of echo curves can be identified, which corresponds exactly to the collection that can be established by a virtual antenna apparatus 134a belonging to the antenna apparatus 134, as shown in FIG. 3C. In other words, using time multiplexing and a suitable evaluation using the transmitting elements 144a-144d and receiving elements 146a-146c arranged in a T shape, the same or similar measuring result can be achieved as with the rectangular virtual array 134a of transmitting elements 144 and receiving elements 146 shown in FIG. 3C. Since the elements 144, 146 of this virtual array 134a, both in the X-direction and in the Y-direction, have a spacing 150, 152 of less than or equal to half the wavelength of the radar signal used, clear digital and/or analogue beam forming can be carried out on the basis of this data without the measuring precision being reduced by grating lobes that occur.

FIG. 3D illustrates the step of digital beam forming with the aid of the virtually produced array 134a. Using methods for digital beam forming, only a limited angle of deflection 156 can be adjusted in principle. Typical values range here from −60° to +60°, both for the azimuthal direction and for the elevation direction. Since the antenna face 135 is, however, already inclined with respect to the mounting orientation of the fill level measurement device 100 (cf. FIGS. 2 and 3A), this angle range may be sufficient for measuring a portion 107a of the bulk material surface 107, in particular regardless of the degree to which the container 105 is filled, in other words, in particular even when the container 105 is virtually completely full.

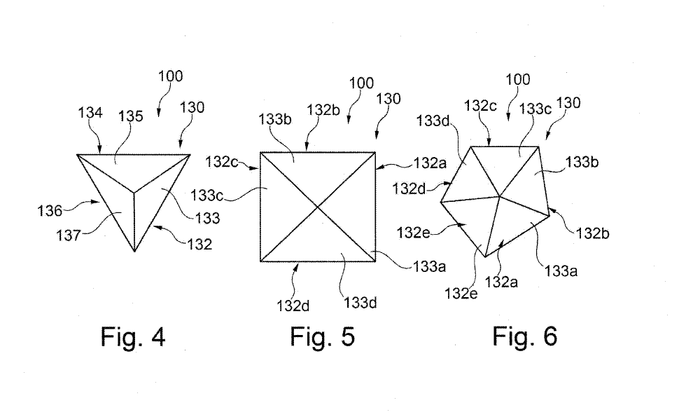

FIG. 4 shows the topology-detecting fill level measurement device 100 according to a further exemplary embodiment of the present disclosure. Unless stated otherwise, the fill level measurement device 100 in FIG. 4 has the same or similar features and elements as the fill level measurement devices 100 described herein.

In particular, FIG. 4 shows an exemplary antenna array 130, as viewed from below. The antenna array 130 can have a three-sided pyramidal structure having three antenna faces 133, 135, 137, each of which accommodates an antenna apparatus 132, 134, 136 of the fill level measurement device 100.

FIG. 5 shows the topology-detecting fill level measurement device 100 according to a still further exemplary embodiment of the present disclosure. Unless stated otherwise, the fill level measurement device 100 in FIG. 5 can have the same features and elements as the fill level measurement devices 100 described herein. As illustrated in FIG. 5, another exemplary antenna array 130 can be provided, as viewed from below. The antenna array 130 has four antenna faces 133a-133d and four antenna apparatuses 134a-134d.

FIG. 6 shows the topology-detecting fill level measurement device 100 according to still another exemplary embodiment according to the present disclosure. Unless stated otherwise, the fill level measurement device 100 in FIG. 6 has the same or similar features and elements as the fill level measurement devices 100 described herein. A still further example of the antenna array 130 is shown in FIG. 6, as viewed from below. The antenna array 130 of FIG. 6 can have, e.g., five antenna faces 133a-133e and five antenna apparatuses 134a-134e. Indeed, any number of antenna apparatuses and antenna faces can be provided, the complexity of the antenna array 130 increasing, however, with an increasing number of devices and faces.

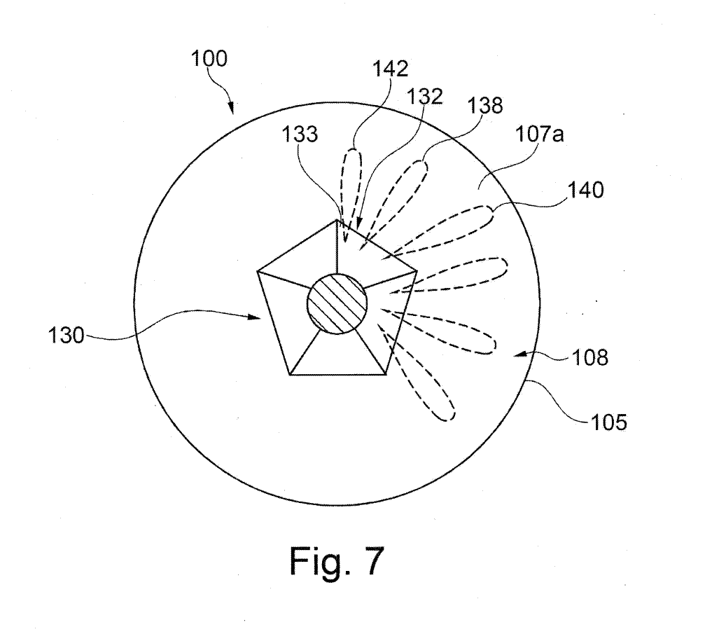

FIG. 7 shown a plan view of the topology-detecting fill level measurement device 100 according to another exemplary embodiment of the present disclosure. Unless stated otherwise, the fill level measurement device 100 in FIG. 7 has the same or similar features and elements as the fill level measurement devices 100 described herein. In FIG. 7, a container 105 is shown and the operating sequence when using a plurality of antenna apparatuses 132 is illustrated. The fill level measurement device 100 shown in FIG. 7 has five antenna faces 133 and five antenna apparatuses 132—analogously to the exemplary embodiment of FIG. 6. Each of these antenna apparatuses 132 or sub-antennas 132 can be activated consecutively by the fill level measurement device 100 and/or the control unit 101 to prevent the measurements influencing one another. Alternatively or in addition, it is possible for the respective antenna apparatuses 132 to use a frequency and/or code multiplexing radar method to prevent the measurements influencing one another during simultaneous transmission. The topology-detecting measurement with the antenna apparatus 132 leads, for example, to measured values, which can be associated with the surface in the region 107a of the bulk material 108 in the container 105. Since the region 107a to be measured by the antenna apparatus 132 can be spatially limited, only a relatively small change in the main beam direction and/or main receiving direction 138, 140, 142 in relation to the surface normal of the antenna apparatus 132 becomes important. This can facilitate the measurement having a high quality.

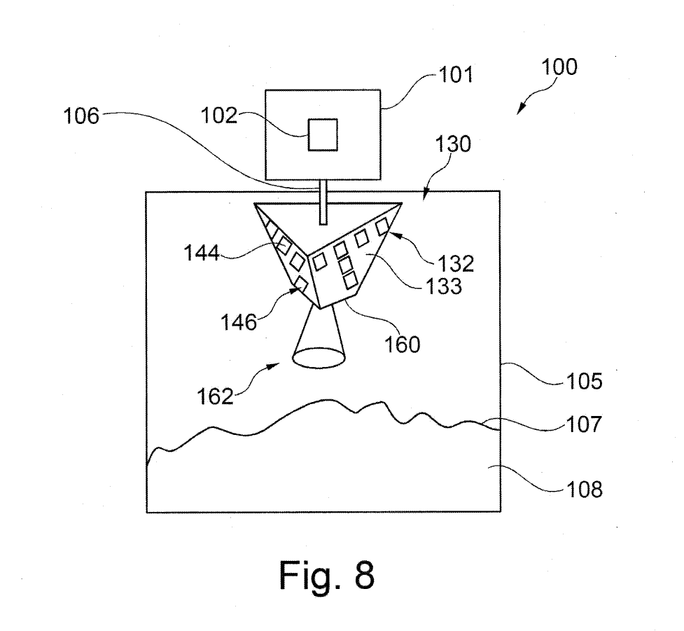

FIG. 8 shows the topology-detecting fill level measurement device 100 according to a further exemplary embodiment of the present disclosure. Unless stated otherwise, the fill level measurement device 100 in FIG. 8 has the same or similar features and elements as the fill level measurement devices 100 described herein. The exemplary fill level measurement device 100 shown in FIG. 8 can be regarded as a combined fill level and topology measurement device. The fill level measurement device has a pyramid-shaped antenna array 130, the main body being designed as a truncated pyramid, on the antenna faces 133 and/or lateral surfaces 133 of which are arranged the transmitting and/or receiving elements 144, 146 used for beam forming. In order to increase the measuring reliability, a further antenna 162, for example, a horn antenna 162, can be arranged and/or mounted on the top face 160 of the truncated pyramid that faces the filling material 108, which further antenna, at predeterminable time intervals, is used to carry out a conventional fill level measurement and therefore to demonstrate the proper function of the fill level measurement device 100, for example in safety-critical systems, with a plausibility observation and/or plausibility check. It is likewise possible to equip the top face 160 with a further antenna apparatus 132. It may also be provided to dispense with the attachment of an additional antenna, and to use the antenna array 130 having the main body resembling a truncated pyramid for pure topology measurement according to the description provided herein. In this exemplary case, the size of the antenna is reduced, which may be advantageous, in particular in small containers 105.

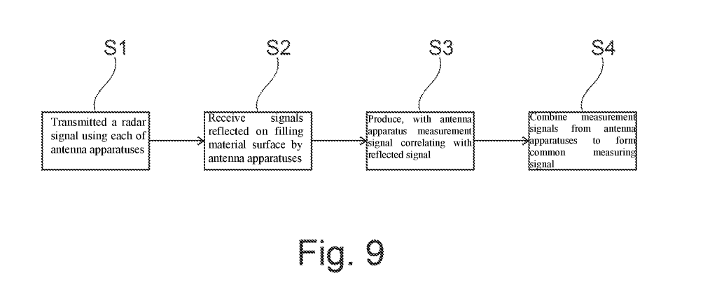

FIG. 9 shows a flowchart for illustrating exemplary procedures of a method for determining the topology of a filling material surface using a fill level measurement device 100, which comprises a control unit 101 and an antenna array 130 having at least three antenna apparatuses 132 each arranged on an antenna face 133, the surface normal vectors of the antenna faces 133 being arranged transversely to one another.

In a first procedure S1, a radar signal is transmitted by each of the three antenna apparatuses 132. In particular, the radar signals can be transmitted in a staggered manner and/or one after the other. In a further procedure S2, the signals reflected on the filling material surface 107 are received by each of the antenna apparatuses 132. In a procedure S3, a measurement signal correlating with the reflected signal is produced by each antenna apparatus 132. In a fourth procedure S4, the measurement signals from the antenna apparatuses 132 are combined by the control unit 101 to form a common measuring signal.

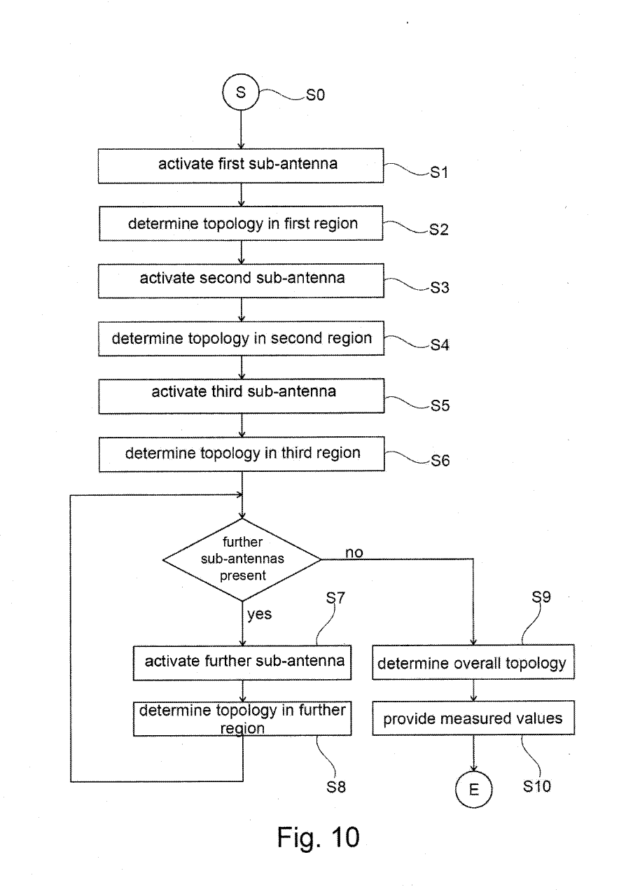

FIG. 10 shows a flow diagram for illustrating steps of a method for determining the topology of a filling material surface according to yet another exemplary embodiment of the present disclosure. For example, FIG. 10 illustrates an exemplary operating sequence of the exemplary fill level measurement device 100 according to various exemplary embodiments of the present disclosure.

The exemplary method begins in the initial state S0. Firstly, in procedure S1, the first sub-antenna 132 and/or antenna apparatus 132 of the antenna array 130 is activated. In procedure S2, using this antenna apparatus 132 according to known methods, such as analogue beam forming, digital beam forming and/or forming virtual arrays, the topology is determined in a first portion of the surface 107 of the bulk material 108. The topology established is stored in a memory of the fill level measurement device 100. In procedure S3, the second sub-antenna 134 and/or antenna apparatus 134 is activated, and, according to the above exemplary model, the topology in a second portion of the bulk material surface 107 is established in step S4. The characteristic values are also stored in the memory. In procedure S5, the third sub-antenna 136 and/or antenna apparatus 136 is activated, and the topology established therewith in step S6 is stored in the memory. If further sub-antennas and/or antenna apparatuses are present, these are can also be activated in procedure S7 and the part topologies of the bulk material surface 107 located below these antenna apparatuses are established in procedure S8 and stored in memory or another storage device. As soon as all the antenna apparatuses have been run through, the resulting overall topology of the bulk material 108 in the container 105 can be established in procedure S9. The course of the surface 107 and/or the values derived therefrom, such as the fill level, mass, volume and/or bulk material position, can be established by the control unit/device 101 in procedure S10 and provided as a combined measurement signal and/or as a measured value, for example passed to a superordinate controller in procedure S10. For example, the measured value in procedure S10 can be transmitted and/or conveyed to a control station. Lastly, the method ends in procedure S11.

It should be pointed out that “comprising” and “having” do not rule out the possibility of other elements or steps and “one” or “a” does not rule out the possibility of a plurality. Furthermore, it should be pointed out that features or steps described with reference to one of the above embodiments may also be used in combination with other features or steps of other above-described embodiments. Reference signs in the claims should not be considered to be restrictive.

Further, it is noted that the foregoing merely illustrates the exemplary principles of the present disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties, as applicable.

What is claimed is:

1. A fill level measurement device for determining a topology of a filling material surface, comprising:
an antenna array having at least three antenna apparatuses, each of antenna apparatuses being designed or configured to transmit a radar signal and receive a signal reflected on the filling material surface; and
a control device,
wherein the antenna array includes at least three antenna faces having surface normal vectors that are arranged substantially transversely to one another,
wherein a respective one of the antenna apparatus is arranged on each antenna face so that a different solid angle range is detectable by each of the antenna apparatuses,
wherein each of the antenna apparatuses is designed or configured to generate a measurement signal based on the reflected signal, and
wherein the control device is designed or configured to at least one of:
process the measurement signals from the antenna apparatuses further, or
combine the measurement signals to form a common measuring signal.

2. The fill level measurement device according to claim 1, wherein the fill level measurement device is configured to vary each of the solid angle ranges that are detectable by the antenna apparatuses using at least one of analogue beam forming or digital beam forming.

3. The fill level measurement device according to claim 1, wherein an angle of deflection between a main beam direction of each of the antenna apparatuses and the associated surface normal vector of the respective antenna face is in a range of approximately 45°.

4. The fill level measurement device according to claim 1, wherein each of the antenna apparatuses has at least one transmitting element configured to transmit the radar signal and at least two receiving elements configured to receive the reflected signal.

5. The fill level measurement device according to claim 1, wherein each of the antenna apparatuses has at least two transmitting elements configured to transmit the radar signal and at least one receiving element configured to receive the reflected signal.

6. The fill level measurement device according to claim 4, wherein at least one of:
the transmitting elements and the receiving elements of the antenna apparatuses are arranged over the entire surface of the associated antenna faces, or
directly adjacent ones of at least one of the transmitting elements or receiving elements of each of the antenna apparatuses are spaced apart from one another at a spacing of less than or equal to half the wavelength of the radar signal.

7. The fill level measurement device according to claim 5, wherein at least one of:
the transmitting elements and the receiving elements of the antenna apparatuses are arranged over the entire surface of the associated antenna faces, or
directly adjacent ones of at least one of the transmitting elements or receiving elements of each of the antenna apparatuses are spaced apart from one another at a spacing of less than or equal to half the wavelength of the radar signal.

8. The fill level measurement device according to claim 4, wherein the transmitting elements and the receiving elements of the antenna apparatuses are arranged in a T shape on the respective associated antenna faces.

9. The fill level measurement device according to claim 5, wherein the transmitting elements and the receiving elements of the antenna apparatuses are arranged in a T shape on the respective associated antenna faces.

10. The fill level measurement device according to claim 1, wherein a position of the antenna array relative to the control device is fixed.

11. The fill level measurement device according to claim 1, wherein the antenna apparatuses are operated sequentially with respect to one another, each provided in different frequency bands or using a code multiplexing procedure.

12. The fill level measurement device according to claim 1, wherein the three antenna faces form lateral surfaces of a pyramid or a truncated pyramid of the antenna array, or wherein the antenna faces are at least partially connected to one another.

13. The fill level measurement device according to claim 1, wherein the antenna array has more than three antenna apparatuses and more than three antenna faces, and wherein one of the antenna apparatuses is arranged on each of the antenna faces.

14. The fill level measurement device according to claim 1, wherein the antenna array has a top face on which a further antenna apparatus is arranged.

15. The fill level measurement device according to claim 1, wherein the control device is designed or configured to establish at least one of (i) the topology of the filling material surface, (ii) a density value of a filling material, (iii) a mass of the filling material, (iv) a volume of the filling material, or (v) a viscosity of the filling material on the basis of at least some of the measurement signals from the antenna apparatuses.

16. A method for determining the topology of a filling material surface using a fill level measurement device which comprises a control device and an antenna array having at least three antenna apparatuses, wherein each of the antenna apparatuses is arranged on a respective antenna face, wherein surface normal vectors of the antenna faces are arranged transversely to one another, the method comprising:
transmitting a radar signal using each of the antenna apparatuses;
receiving a signal reflected on the filling material surface using each of the antenna apparatuses;
producing a measurement signal correlating with the reflected signal using each of the antenna apparatus; and
combining the measurement signals from the antenna apparatuses to form a common measurement signal using the control device.

17. A system having a computer program stored therein, which, when executed on a control device of a fill level measurement device of the system, the control device is configured to instruct the fill level measurement device to carry out procedure, the fill level measurement device comprises a control device and an antenna array having at least three antenna apparatuses, wherein each of the antenna apparatuses is arranged on a respective antenna face, wherein surface normal vectors of the antenna faces are arranged transversely to one another, wherein the procedures cause the control device to perform steps comprising:
transmitting a radar signal using each of the antenna apparatuses;
receiving a signal reflected on the filling material surface using each of the antenna apparatuses;
producing a measurement signal correlating with the reflected signal using each of the antenna apparatus; and
combining the measurement signals from the antenna apparatuses to form a common measurement signal using the control device.

18. A non-transitory computer-readable medium which includes a computer software program thereon, which, when executed on a control device of a fill level measurement device of the system, the control device is configured to instruct the fill level measurement device to carry out procedure, the fill level measurement device comprises a control device and an antenna array having at least three antenna apparatuses, wherein each of the antenna apparatuses is arranged on a respective antenna face, wherein surface normal vectors of the antenna faces are arranged transversely to one another, wherein the procedures cause the control device to perform steps comprising:
transmitting a radar signal using each of the antenna apparatuses;
receiving a signal reflected on the filling material surface using each of the antenna apparatuses;
producing a measurement signal correlating with the reflected signal using each of the antenna apparatus; and
combining the measurement signals from the antenna apparatuses to form a common measurement signal using the control device.
